(19) United States
(12) Patent Application Publication
(10) Pub. No.: US 2002/0002256 A1
(43) Pub. Date: Jan. 3, 2002

(54) CATALYST COMPOSITION FOR THE POLYMERIZATION OF OLEFINS

(76) Inventor: THOMAS HENRY PETERSON, CHARLESTON, WV (US)

Correspondence Address: UNIVATION TECHNOLOGIES, 5555 SAN FELIPE, SUITE 1950, HOUSTON, TX, 77056

(21) Appl. No.: 09/154,459

(22) Filed: Sep. 16, 1998

(51) Int. Cl. C08F 4/60

(52) U.S. Cl. 526/133; 526/134; 526/170; 502/104; 502/117; 502/152

(57) ABSTRACT

A catalyst composition for the polymerization of olefins is provided. The catalyst composition comprises a monocycloalkadienyl/metal/ligand catalyst precursor, wherein at least one ligand is capable of multihapto attachment to the metal atom through a carbon or hydrogen atom, and a cocatalyst capable of irreversibly abstracting a ligand from the catalyst precursor.

The present invention relates to a catalyst composition useful for the polymerization of olefins. The catalyst composition comprises a monocycloalkadienyl/metal/ligand catalyst precursor, wherein at least one ligand is capable of multihapto attachment to the metal through a carbon or hydrogen atom, and a cocatalyst capable of irreversibly abstracting a ligand from the catalyst precursor.

### BACKGROUND OF THE INVENTION

A variety of catalyst compositions containing single site catalyst precursors have been shown to be highly useful in the preparation of polyolefins, producing relatively homogeneous copolymers at good polymerization rates and allowing one to tailor the properties of the finished polymer closely. In contrast to traditional Ziegler-Natta catalyst compositions, single site catalyst compositions comprise catalytic compounds in which each catalyst composition molecule contains one or only a few polymerization sites.

The most well known category of single site catalyst precursors is metallocenes of the general formula Cp₂MX₂ wherein Cp is a cycloalkadienyl ligand, typically cyclopentadienyl or indenyl, M is a metal, usually from Group 4, and X is a halogen or alkyl group. However, recently single site catalyst precursors containing a combination of cycloalkadienyl and multihapto ligands bound to a metal atom have been described. For example, U.S. Pat. No. 5,527,752 describes a broad class of monocycloalkadienyl catalyst precursors that are complexes of a transition metal, a substituted or unsubstituted cycloalkadienyl ligand, and one or more heteroallyl moieties. These precursors may be activated with aluminoxanes or boron compounds.

Pellecchia et al., Makromol. Chem., Rapid Commun., 12:663 (1991) relates to the polymerization behavior of organometallic compounds of Group 4 metals. In particular, CpZrBz₃, wherein Bz is a benzyl group, activated with methylaluminoxane (MAO) or N,N-dimethylanilinium tetrakis(pentafluorophenyl)borate (AFPB) was used by the authors to polymerize ethylene. Based on the data given in Table 1, the catalyst composition containing MAO as the cocatalyst was considerably more active than the catalyst composition containing AFPB. Pellecchia et al., Macromol. Symp.,89:335 (1995) discloses that only unstable and unisolable compositions are obtained from the reaction of CpZrBz₃ and [HNR₃]⁺[B(C₆F₅)₄]- or [CPh3]+[B(C6F5)4]-.

The present invention revolves around the discovery that single site catalyst precursors comprising at least one ligand capable of multihapto attachment to the metal atom through carbon and/or hydrogen atoms combined with a cocatalyst capable of irreversibly abstracting a ligand (multihapto or other) from the catalyst precursor are particularly effective for the polymerization of olefins. Contrary to the teachings of Pellecchia et al., such catalyst compositions are indeed stable. This unique combination of catalyst precursor and cocatalyst provides an extremely active catalyst composition.

### SUMMARY OF THE INVENTION

In one embodiment, the invention provides a catalyst composition for the polymerization of olefins comprising: a) a catalyst precursor of the formula LMⁿ⁺(X)_{y}(R)_{(n-y-1)}, wherein L is a cycloalkadienyl ligand but not cyclopentadienyl or pentamethylcyclopentadienyl; M is an element selected from Groups 3 to 10 and the Lanthanides; each X is an anion; each R is a hydride or a group containing at least two carbons capable of attachment to M in a multihapto manner through at least one hydrogen or carbon atom; n is the valence of M; and y is an integer from 0 to 5; and b) a cocatalyst capable of irreversibly abstracting an X or an R from the catalyst precursor such that at least one metal-carbon or metal-hydrogen bond is retained in the resulting activated catalyst.

The invention also provides processes for preparing cycloalkadienyl/metal catalyst precursors, and a process for the polymerization of olefins, which comprises contacting olefins under polymerization conditions with the above catalyst composition.

### DETAILED DESCRIPTION OF THE INVENTION

Olefin polymers that may be produced according to the invention include, but are not limited to, ethylene homopolymers, homopolymers of linear or branched higher alpha-olefins containing 3 to about 20 carbon atoms, and interpolymers of ethylene and such higher alpha-olefins, with densities ranging from about 0.86 to about 0.96. Suitable higher alpha-olefins include, for example, propylene, 1-butene, 1-pentene, 1-hexene, 4-methyl-1-pentene, 1-octene, and 3,5,5-trimethyl-1-hexene. Olefin polymers according to the invention may also be based on or contain conjugated or non-conjugated dienes, such as linear, branched, or cyclic hydrocarbon dienes having from about 4 to about 20, preferably 4 to 12, carbon atoms. Preferred dienes include 1,4-pentadiene, 1,5-hexadiene, 5-vinyl-2-norbornene, 1,7-octadiene, vinyl cyclohexene, dicyclopentadiene, butadiene, isobutylene, isoprene, ethylidene norbornene, norbornadiene and the like. Aromatic compounds having vinyl unsaturation such as styrene and substituted styrenes, and polar vinyl monomers such as acrylonitrile, maleic acid esters, vinyl acetate, acrylate esters, methacrylate esters, vinyl trialkyl silanes and the like may be polymerized according to the invention as well. Specific olefin polymers that may be made according to the invention include, for example, polyethylene, polypropylene, ethylene/propylene rubbers (EPR's), ethylene/propylene/diene terpolymers (EPDM's), polybutadiene, polyisoprene and the like.

The catalyst composition comprises a catalyst precursor of the formula LMⁿ⁺(X)_{y}(R)_{(n-y-1)}. L is any cycloalkadienyl ligand except for cyclopentadienyl and pentamethylcyclopentadienyl. L may be for example methylcyclopentadienyl, 1,2-dimethylcyclopentadienyl, 1,3-dimethylcyclopentadienyl, 2,3,4,5-tetramethylcyclopentadienyl, trimethylsilylcyclopentadienyl, or phenylcyclopentadienyl. L may also be any unsubstituted or substituted indenyl or fluorenyl ligand such as indenyl, fluorenyl, trimethylsilylindenyl, 2-methylindenyl, 2-arylindenyl, or trimethylsilylfluorenyl. Preferably, L is selected from methylcyclopentadienyl, 1,3-dimethylcyclopentadienyl, indenyl, fluorenyl, and 2-arylindenyl. More preferably, L is selected from methylcyclopentadienyl, 1,3-dimethylcyclopentadienyl, indenyl, and fluorenyl. Most preferably, L is methylcyclopentadienyl.

M is an element selected from Groups 3 to 10 and the Lanthanides. Preferably, M is selected from Groups 3, 4, 5, 6 and the Lanthanides. More preferably, M is a Group 4 element. Zirconium in particular is preferred.

Each X is an anion. Preferably, each X is selected from hydrogen, or unsubstituted or substituted aryl, alkyl, alkenyl, alkylaryl, or arylalkyl radicals having 1-20 carbon atoms. Alternatively, X may be a group of atoms or a single atom bound to M via an atom selected from the halides, chalcogenides and pnictides. More preferably, each X is selected from arylalkyl, alkoxy, aryloxy, alkylamido, arylamido, or halide. Most preferably, X is benzyl.

Each R is independently a hydride or a group containing at least two carbons capable of attachment to M in a multihapto manner through at least one hydrogen or carbon atom. For purposes of the invention, “capable of multihapto attachment” means that the R group possesses at least one mode of bonding in which more than one atom is capable of creating a stabilizing interaction through electron donation to the metal center. Examples of R include benzyl, methylnaphthyl, allyl, crotyl, and cinnamyl. Preferably, R is benzyl, methylnaphthyl, allyl, or crotyl. More preferably, R is benzyl or allyl. Most preferably, R is benzyl.

n is the valence of M.

y is an integer from 0 to 5.

The catalyst precursor may be made by any means, and the invention is not limited thereby. For example, one method of making the catalyst precursor is via metathesis reaction of a homoleptic metal alkyl complex with an alkaline or alkaline earth metal salt of a cycloalkadiene. The reaction may be carried out in a suitable solvent.

Preferably, the homoleptic metal alkyl complex comprises a metal selected from Groups 4, 5, or 6, more preferably from Group 4. Examples of homoleptic metal alkyl complexes include tetrabenzyltitanium, tetrabenzylzirconium, tetrabenzylhafnium, tetrakis(trimethylsilylmethyl)zirconium, tetrakis(2,2-dimethylpropyl)zirconium, tetramethylzirconium, tetrakis(2-methyl-2-phenylpropyl)zirconium, pentakis(2,2-dimethylpropyl)tantalum, and hexamethyltungsten.

Examples of alkaline metal and alkaline earth metal salts of cycloalkadienyl ligands include cyclopentadienyllithium and its sodium and potassium congeners, indenyllithium and its sodium and potassium congeners, and fluorenyllithium and its sodium and potassium congeners. Other examples of alkaline metal and alkaline earth metal salts of cycloalkadienyl ligands include bis(cyclopentadienyl)magnesium and bis(cyclopentadienyl)calcium. Salts of substituted cycloalkadienyl ligands may be used as well.

For example, the catalyst precursor (methylcyclopentadienyl)tribenzylzirconium may be made by reacting a well-stirred toluene solution of tetrabenzylzirconium at room temperature and ambient pressure with one equivalent of methylcyclopentadienyllithium for a period of 12 hours. The product can then be isolated from the benzyllithium byproduct either by precipitation of benzyllithium by addition of an equivalent volume of hexane or by reacting the benzyllithium with chlorotrimethylsilane followed by filtration from the lithium chloride byproduct. The product can then be recrystallized from a hydrocarbon solvent.

The catalyst precursor can also be prepared by the metathesis reaction of a metal alkyl-borate salt with an alkaline metal or alkaline earth metal salt of a cycloalkadiene. The reaction may optionally be carried out in a suitable solvent.

Examples of metal alkyl-borate salts include tribenzylzirconium-η⁶-(tetraphenylborate) (which can be prepared according to the procedure of Bochmann et al., J. Chem. Soc., Chem. Comm., 1990, 1038-1039) and tribenzylzirconium-[η⁶-benzyl-tris(pentafluorophenyl)-borate] (which can be prepared according to the procedure of Pellecchia et al., J. Mol. Catal. 82, 1993, 57-65).

Examples of alkaline metal and alkaline earth metal salts of cycloalkadienyl ligands are given above.

In one example according to this second method of preparation, a stirred toluene solution of tribenzylzirconium-η⁶-(tetraphenylborate) under an inert atmosphere may be reacted at ambient temperature and pressure with one equivalent of fluorenylpotassium. After stirring for approximately 12 hours, the reaction mixture is filtered to remove potassium tetraphenylborate and fluorenyltribenzylzirconium is isolated by removal of the solvent from the filtrate. The zirconium complex may then be purified by recrystallization from toluene-hexane.

In a third method, the catalyst precursor may be prepared by the metathesis reaction of a cycloalkadiene with a metal alkyl-borate salt. Suitable solvents may again be used.

Examples of metal alkyl-borate salts are described above. Examples of cycloalkadienes include cyclopentadiene, indene, fluorene, trimethylsilylcyclopentadiene, trimethylsilylindene and other substituted congeners thereof.

In one example according to this method, a stirred toluene solution of tribenzylzirconium-[η⁶-benzyl-tris(pentafluorophenyl)borate] under an inert atmosphere is reacted with one equivalent of trimethylsilylindene for a period of 12 hours at ambient temperature and pressure. (1-Trimethylsilylindenyl)dibenzylzirconium-[η⁶-benzyl-tris(pentafluorophenyl)borate] is precipitated as a bright yellow crystalline solid, which may be washed with toluene and dried in vacuo to give the desired complex in pure form.

Aside from preparation of monocycloalkadienyl/metal/ligand catalyst precursors according to the present invention, the above three methods may be used to prepare other cycloalkadienyl/metal complexes useful as catalyst precursors, such as asymmetric bis(cycloalkadienyl) metal complexes typically used as catalyst precursors for polymerizing propylene.

Preferably, the catalyst precursor has the formula:

LMⁿ⁺(CH₂Ph)ₙ₋₁

wherein L, M, and n have the meanings stated above, and Ph is phenyl.

In a particularly preferred embodiment of the invention, the catalyst precursor has one of the formulas:

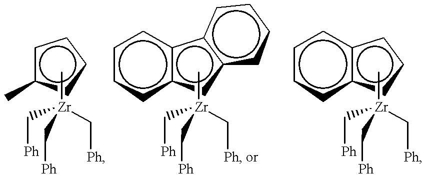

The cocatalyst is one that is capable of irreversibly abstracting a ligand, i.e., an X or an R, from the catalyst precursor such that at least one metal-carbon or metal-hydrogen bond remains in the activated catalyst. For purposes of this invention, “irreversible” means that the reaction that takes place between the catalyst precursor and the cocatalyst is exothermic so as to render the microscopic reverse of the reaction very improbable. Further, the cocatalyst should be chosen such that the product of the abstraction/activating step is one that does not interact with the active catalyst site so as to severely limit access of reactive monomers to the active species. In addition, the cocatalyst is a compound capable of generating a counterionic partner for the active catalyst composition that also does not interact strongly with the catalytic site so as to hinder the polymerization process.

Cocatalysts according to the invention include for example salts, such as carbenium or ammonium salts, of borates and aluminates. Preferably, the cocatalyst is a salt comprising a cation selected from triphenylcarbenium, dimethylanilinium, and trialkylammonium and an anion selected from borate and aluminate. More preferably, the cocatalyst is a borate of the formula BR″₄_{⁻}, wherein R″ is a strong-electron withdrawing moiety such as perfluoroaryl, perfluoroalkyl or perfluoroalkyl-substituted moieties. Most preferably the cocatalyst is triphenylcarbenium tetrakis (pentafluorophenyl)borate.

The activated catalyst composition according to the invention is formed by reacting one of the above cocatalysts with a catalyst precursor. For example, (methylcyclopentadienyl)tribenzylzirconium may be reacted with triphenylcarbenium tetrakis(pentafluorophenyl)borate to make an activated catalyst composition as follows:

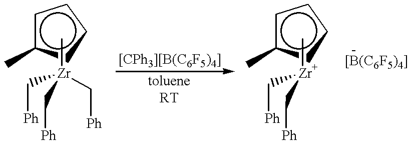

The catalyst composition may be impregnated onto a solid, inert support, in liquid form such as a solution or dispersion, spray dried, in the form of a prepolymer, or formed in-situ during polymerization. Particularly preferred among these is a catalyst composition that is spray dried as described in U.S. Pat. No. 5,648,310 or in liquid form as described in U.S. Pat. No. 5,317,036. For example, the catalyst composition may be introduced into the reaction zone in unsupported, liquid form as described in U.S. Pat. No. 5,317,036. As used herein, “unsupported, liquid form” includes liquid catalyst precursor, liquid cocatalyst, solution(s) or dispersions thereof in the same or different solvent(s), and combinations thereof. Unsupported, liquid form catalyst compositions have a number of practical benefits. Unsupported catalyst compositions avoid the costs associated with support material and its preparation, and provide for the realization of a very high catalyst surface area to volume ratio. Furthermore, unsupported catalyst compositions produce polymers having a much lower residual ash content than polymers produced using supported catalyst compositions.

In the case of a supported catalyst composition, the catalyst composition may be impregnated in or deposited on the surface of an inert substrate such as silica, carbon black, polyethylene, polycarbonate porous crosslinked polystyrene, porous crosslinked polypropylene, alumina, thoria, zirconia, or magnesium halide (e.g., magnesium dichloride), such that the catalyst composition is between 0.1 and 90 percent by weight of the total weight of the catalyst composition and the support.

The catalyst composition may be used for the polymerization of olefins by any suspension, solution, slurry, or gas phase process, using known equipment and reaction conditions, and is not limited to any specific type of reaction system. Generally, olefin polymerization temperatures range from about 0° C. to about 200° C. at atmospheric, subatmospheric, or superatmospheric pressures. Slurry or solution polymerization processes may utilize subatmospheric or superatmospheric pressures and temperatures in the range of about 40° C. to about 110° C. A useful liquid phase polymerization reaction system is described in U.S. Pat. No. 3,324,095. Liquid phase reaction systems generally comprise a reactor vessel to which olefin monomer and catalyst composition are added, and which contains a liquid reaction medium for dissolving or suspending the polyolefin. The liquid reaction medium may consist of the bulk liquid monomer or an inert liquid hydrocarbon that is nonreactive under the polymerization conditions employed. Although such an inert liquid hydrocarbon need not function as a solvent for the catalyst composition or the polymer obtained by the process, it usually serves as solvent for the monomers employed in the polymerization. Among the inert liquid hydrocarbons suitable for this purpose are isopentane, hexane, cyclohexane, heptane, benzene, toluene, and the like. Reactive contact between the olefin monomer and the catalyst composition should be maintained by constant stirring or agitation. The reaction medium containing the olefin polymer product and unreacted olefin monomer is withdrawn from the reactor continuously. The olefin polymer product is separated, and the unreacted olefin monomer and liquid reaction medium are recycled into the reactor.

Preferably, gas phase polymerization is employed, with superatmospheric pressures in the range of 1 to 1000, preferably 50 to 400 psi, most preferably 100 to 300 psi, and temperatures in the range of 30 to 130° C., preferably 65 to 110° C. Stirred or fluidized bed gas phase reaction systems are particularly useful. Generally, a conventional gas phase, fluidized bed process is conducted by passing a stream containing one or more olefin monomers continuously through a fluidized bed reactor under reaction conditions and in the presence of catalyst composition at a velocity sufficient to maintain a bed of solid particles in a suspended condition. A stream containing unreacted monomer is withdrawn from the reactor continuously, compressed, cooled, optionally fully or partially condensed as disclosed in U.S. Pat. Nos. 4,528,790 and 5,462,999, and recycled to the reactor. Product is withdrawn from the reactor and make-up monomer is added to the recycle stream. As desired for temperature control of the system, any gas inert to the catalyst composition and reactants may also be present in the gas stream. In addition, a fluidization aid such as carbon black, silica, clay, or talc may be used, as disclosed in U.S. Pat. No. 4,994,534.

Polymerization may be carried out in a single reactor or in two or more reactors in series, and is conducted substantially in the absence of catalyst poisons. Organometallic compounds may be employed as scavenging agents for poisons to increase the catalyst activity. Examples of scavenging agents are metal alkyls, preferably aluminum alkyls, most preferably triisobutylaluminum.

Conventional adjuvants may be included in the process, provided they do not interfere with the operation of the catalyst composition in forming the desired polyolefin. Hydrogen or a metal or non-metal hydride, e.g., a silyl hydride, may be used as a chain transfer agent in the process. Hydrogen may be used in amounts up to about 10 moles of hydrogen per mole of total monomer feed.

Aluminum alkyls such as trimethylaluminum, triethylaluminum, or triisobutylaluminum may also be added to the process, or to the catalyst composition directly.

The following examples further illustrate the invention.

### EXAMPLES

The following catalyst precursors and cocatalysts were used in the examples:

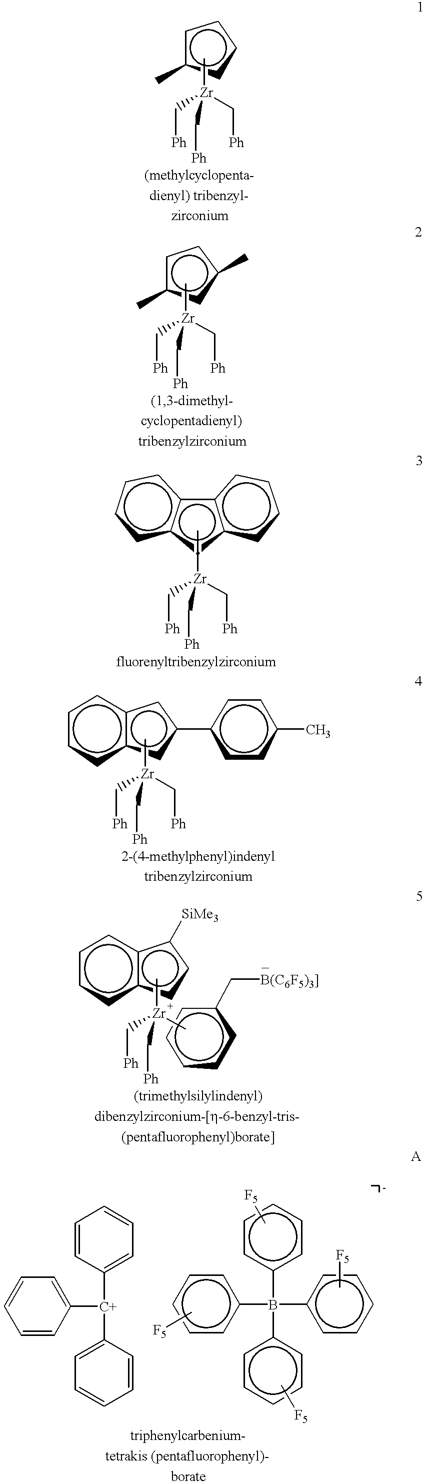

Tetrabenzylzirconium was purchased from Boulder Scientific and was purified by Soxhlet extraction with pentane/ether prior to use.

Triphenylcarbenium tetrakis (pentafluorophenyl)borate (A), N,N-dimethylanilinium tetrakis (pentafluorophenyl)borate and Scientific and Akzo Nobel. Tri-n-hexylammonium tetrakis(pentafluorophenyl)borate (B) was prepared by reaction of tri-n-hexylamine with N,N-dimethylanilinium tetrakis (pentafluorophenyl)borate.

Modified methylalumoxane was obtained from Akzo Nobel.

All solvents were purified by successive passage through a bed of activated alumina and supported copper chromite deoxo catalyst.

Tribenzylzirconium-η⁶-(tetraphenylborate) was prepared by the method of Bochmann et al.(J. Chem. Soc., Chem. Comm., 1990, 1038-1039).

Tribenzylzirconium-η⁶-(benzyl-tris(pentafluorophenyl)borate) was prepared according to the procedure of Pellecchia et al. (J. Mol. Catal. 82, 1993, 57-65).

Preparation of (Methylcyclopentadienyl)tribenzylzirconium (1) and (1,3-dimethylcyclopentadienyl)tribenzylzirconium (2)

Tetrabenzylzirconium (15 g, 33 mmol) and methylcyclopentadienyllithium (2.37 g, 28 mmol) were dissolved in toluene (200 mL) at ambient temperature. After stirring for 5 hours, chlorotrimethylsilane (3.57 g, 4.17 mL, 33 mmol) was added via syringe and the stirred solution was maintained at ambient temperature overnight. After filtration through Celite, the volatile materials were removed in vacuo and the residue was recrystallized from toluene/hexane at −35° C. to afford 9.65 g of pure 1 in 78% yield from the first crop.

(1,3-dimethylcyclopentadienyl)tribenzylzirconium (2) was prepared analogously.

Preparation of Fluorenyltribenzylzirconium (3) and 2-(4-Methylphenyl)indenyltribenzylzirconium

Tribenzylzirconium-η⁶-(tetraphenylborate) (200 mg, 0.29 mmol) and fluorenylpotassium (59 mg, 0.29 mmol) were suspended in a solution of toluene (10 mL) and tetrahydrofuran) (1 mL) and were stirred for 2 hours at ambient temperature. After filtration through a Celite pad, the filtrate was pumped to dryness and the residue was recrystallized from toluene/hexane at −30° C. to afford 73 mg (0.14 mmol) of fluorenyltribenzylzirconium (3) as a bright yellow crystalline solid.

2-(4-Methylphenyl)indenyltribenzylzirconium (4) was prepared analogously.

Preparation of (1-trimethylsilylindenyl)tribenzylzirconium (5)

Tribenzylzirconium-η⁶-(benzyl-tris(pentafluorophenyl)borate) (895 mg, 0.92 mmol) and 1-trimethylsilylindene (173.8 mg, 0.92 mmol) were dissolved in toluene (19 ml) and stirred at ambient temperature overnight. The product was filtered on a glass frit, washed with toluene and dried in vacuo to give (1-trimethylsilylindenyl)tribenzylzirconium (5) as a bright yellow crystalline solid.

### Example 1

Slurry-Phase Ethylene-1-Hexene Copolymerization by (MeCp)Zr(CH₂Ph)₃/Triphenylcarbenium tetrakis(pentafluorophenyl)borate.

Into a 1 L stirred autoclave reactor under a nitrogen purge and maintained at temperature of 55° C. was placed 600 mL of dry hexane. 1-Hexene (43 mL) and triisobutylaluminum (100 μL of 1 M solution in hexane, 100 μmol) were added via syringe. After stirring for approximately 10 minutes, the reactor was pressurized to 85 p.s.i with ethylene.

A catalyst solution was prepared by dissolving a solid mixture of (MeCp)Zr(CH₂Ph)₃ (1) (5.0 mg, 11.3 μmol) and triphenylcarbenium tetrakis(pentafluorophenyl)borate (A)(10.4 mg, 11.3 μmol, 1 equiv) in a solution of triisobutylaluminum (10.2 mg, 13 μL, 52 μmol, 4.6 equiv) in toluene (10 mL). The polymerization was carried out by injecting the activated catalyst solution into the reactor at 55° C. with rapid ramping of the temperature of the reactor to a set temperature of 75° C. after an initial exotherm and with maintenance of the set temperature and pressure for a period of 30 minutes. Polymerization activities were calculated as g polymer (mmol Zr)⁻¹(h)⁻¹ (100 p.s.i. ethylene)⁻¹.

The results are shown in Table 1 below.

### Example 2

Slurry-Phase Ethylene-1-Hexene Copolymerization by (1,3-Me₂Cp)Zr(CH₂Ph)₃/Triphenylcarbenium tetrakis(pentafluorophenyl)borate.

Example 2 was carried out in the same manner as Example 1, except that the catalyst composition was prepared by dissolving a solid mixture of (1,3-Me₂Cp)Zr(CH₂Ph)₃ (2) (5.0 mg, 10.8 μmol) and triphenylcarbenium tetrakis(pentafluorophenyl)borate (A)(10.0 mg, 10.8 μmol, 1 equiv) in a solution of triisobutylaluminum (10.2 mg, 13 μL, 52 μmol, 4.8 equiv) in toluene (20 mL).

The results are shown in Table 1 below.

### Example 3

Slurry-Phase Ethylene-1-Hexene Copolymerization by (Fluorenyl)Zr(CH₂Ph)₃/Triphenylcarbenium tetrakis(pentafluorophenyl)borate.

Example 3 was carried out in the same manner as Example 1, except that the catalyst composition was prepared by dissolving a solid mixture of (fluorenyl)Zr(CH₂Ph)₃ (3) (6.0 mg, 11.3 μmol) and triphenylcarbenium tetrakis(pentafluorophenyl)borate (A) (10.4 mg, 11.3 μmol, 1 equiv) in a solution of triisobutylaluminum (10.2 mg, 13 μL, 52 μmol, 4.6 equiv) in toluene (5 mL).

The results are shown in Table 1 below.

### Example 4

Slurry-Phase Ethylene-1-Hexene Copolymerization by 2-(p-Tolylindenyl)Zr(CH₂Ph)₃/Triphenylcarbenium tetrakis(pentafluorophenyl)borate.

Example 4 was carried out in the same manner as Example 1, except that the catalyst composition was prepared by dissolving a solid mixture of 2-(p-tolylindenyl)Zr(CH₂Ph)₃ (4) (5.0 mg, 8.8 μmol) and triphenylcarbenium tetrakis(pentafluorophenyl)borate (A) (9.24 mg, 10.0 μmol, 1.1 equiv) in a solution of triisobutylaluminum (10.2 mg, 13 μL, 52 μmol, 4.6 equiv) in toluene (10 mL).

The results are shown in Table 1 below.

### Example 5

Slurry-Phase Ethylene-1-Hexene Copolymerization by (1-Trimethylsilylindenyl)Zr(CH₂Ph)₂-(η⁶-(PhCH₂B(C₆F₅)₃))/Triphenylcarbenium tetrakis(pentafluorophenyl)borate.

Example 5 was carried out in the same manner as Example 1, except that the catalyst composition was prepared by dissolving a solid mixture of (1-trimethylsilylindenyl)Zr(CH₂Ph)₂-(η⁶-(PhCH₂B(C₆F₅)₃) (5) (10.0 mg, 8.7 μmol) and triphenylcarbenium tetrakis(pentafluorophenyl)borate (A)(9.2 mg, 10.0 μmol, 1.15 equiv) in a solution of triisobutylaluminum (10.2 mg, 13 μL, 52 μmol, 6.0 equiv) in toluene (5 mL).

The results are shown in Table 1 below.

### Example 6

Slurry-Phase Ethylene-1-Hexene Copolymerization by (MeCp)Zr(CH₂Ph)₃/Triphenylcarbenium tetrakis(pentafluorophenyl)borate at Substoichiometric Cocatalyst Ratios

Example 6 was carried out in the same manner as Example 1, except that the catalyst composition was prepared using 0.75 equivalents of triphenylcarbenium tetrakis(pentafluorophenyl)borate

The results are shown in Table 2 below.

### Example 7

Slurry-Phase Ethylene-1-Hexene Copolymerization by (MeCp)Zr(CH₂Ph)₃/Triphenylcarbenium tetrakis(pentafluorophenyl)borate at Substoichiometric Cocatalyst Ratios

Example 7 was carried out in the same manner as Example 1, except that the catalyst solution was prepared using 0.50 equivalents of triphenylcarbenium tetrakis(pentafluorophenyl)borate (A).

The results are shown in Table 2

### Example 8

Slurry-Phase Ethylene-1-Hexene Copolymerization by (MeCp)Zr(CH₂Ph)₃/Modified Methylalumoxane.

Example 8 was carried out in the same manner as Example 1, except that the catalyst composition was prepared by dissolving (MeCp)Zr(CH₂Ph)₃ (1) (5.0 mg, 11.3 μmol) in a 3 mL of a 17wt % solution of 1-hexene in hexane and reacting this solution with modified methylalumoxane (2 mL of 1.68 M solution in heptane, 3.36 mmol Al, 297 equiv).

The results are shown in Table 2 below.

### Example 9

Slurry-Phase Ethylene-1-Hexene Copolymerization by (MeCp)Zr(CH₂Ph)₃/Tris(pentafluorophenyl)borane

Example 9 was carried out in the same manner as Example 1, except that the catalyst composition was prepared by dissolving a solid mixture of (MeCp)Zr(CH₂Ph)₃ (1) (5.0 mg, 11.3 μmol) and tris(pentafluorophenyl)borane (C)(11.6 mg, 22.7 μmol, 2.0 equiv) in toluene (5 mL).

The results are shown in Table 2 below.

### Example 10

Slurry-Phase Ethylene-1-Hexene Copolymerization by (MeCp)Zr(CH₂Ph)₃/Tris(pentafluorophenyl)borane

Example 10 was carried out in the same manner as Example 9, except that the catalyst composition was prepared using 1.5 equivalents of tris(pentafluorophenyl)borane (C).

The results are shown in Table 2 below.

### Example 11

Slurry-Phase Ethylene-1-Hexene Copolymerization by (MeCp)Zr(CH₂Ph)₃/Tris(pentafluorophenyl)borane

Example 11 was carried out in the same manner as Example 9, except that the catalyst composition was prepared by using 2.0 equivalents of tris(pentafluorophenyl)borane (C).

The results are shown in Table 2.

### Example 12

Slurry-Phase Ethylene-1-Hexene Copolymerization by (1,3-Me₂Cp)Zr(CH₂Ph)₃/Trihexylammonium tetrakis(pentafluorophenyl)borate.

Example 12 was carried out in the same manner as Example 1 except that the catalyst composition was prepared by dissolving a solid mixture of (1,3-Me₂Cp)Zr(CH₂Ph)₃ (2) (5.0 mg, 10.8 μmol) and trihexylammonium tetrakis(pentafluorophenyl)borate (B)(10.3 mg, 10.8 μmol, 1 equiv) in toluene (10 mL).

The results are shown in Table 2 below.

TABLE 1

| | | μmol | polymer | activity |
|---|---|---|---|---|
| Example | Catalyst | catalyst | yield (g) | * |
| 1 | 1 | 0.22 | 90.5 | 949355 |
| 2 | 2 | 0.27 | 71.9 | 621196 |
| 3 | 3 | 0.22 | 24.3 | 254483 |
| 4 | 4 | 0.18 | 4.2 | 55442 |
| 5 | 5 | 0.22 | 14.1 | 153595 |

*activity reported in units of g PE (mmolZr)⁻¹ (h)⁻¹ (100 psi ethylene)⁻¹

TABLE 2

| Exam- | Cata- | Cocata- | Cocatalyst/ | μmol | polymer | |
|---|---|---|---|---|---|---|
| ple | lyst | lyst | catalyst | catalyst | yield (g) | activity* |
| 6 | 1 | A | 0.75 | 0.22 | 3.5 | 36699 |
| 7 | 1 | A | 0.5 | 1.1 | 3.7 | 7759 |
| 8** | 1 | MMAO | 300 | 1 | 4.0 | 9412 |
| 9** | 1 | C | 1.5 | 0.22 | 0 | 0 |
| 10** | 1 | C | 1.5 | 1.1 | 0 | 0 |
| 11** | 1 | C | 2 | 1.1 | 1.2 | 2472 |
| 12 | 2 | B | 1 | 0.53 | 67.4 | 291159 |

*activity reported in units of g PE (mmolZr)⁻¹ (h)⁻¹ (100 psi ethylene)⁻¹
**comparative

I claim:

1. A catalyst composition for the polymerization of olefins comprising:
a) a catalyst precursor of the formula LMⁿ⁺(X)_{y}(R)_{(n-y-1)}, wherein L is a cycloalkadienyl ligand except for cyclopentadienyl and pentamethylcyclopentadienyl; M is an element selected from Groups 3 to 10 and the Lanthanides; each X is an anion; each R is a hydride or a group containing at least two carbons capable of attachment to M in a multihapto manner through at least one hydrogen or carbon atom; n is the valence of M; and y is an integer from 0 to 5.
b) a cocatalyst capable of irreversibly abstracting an X or an R from the catalyst precursor such that at least one metal-carbon or metal-hydrogen bond is retained in the resulting activated catalyst.

2. The catalyst composition of claim 1, wherein the catalyst precursor has the formula:
LMⁿ⁺(CH₂Ph)ₙ₋₁
wherein L is a cycloalkadienyl ligand except for cyclopentadienyl and pentamethylcyclopentadienyl; M is an element selected from Groups 3 to 10 and the Lanthanides; n is the valence of M; y is an integer from 0 to 5; and Ph is phenyl.

3. The catalyst composition of claim 1, wherein the catalyst precursor has a formula selected from the group consisting of:

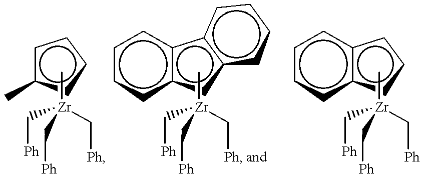

4. The catalyst composition of claim 1, wherein the cocatalyst is a borate of the formula BR″₄_{⁻}, wherein R″ is selected from the group consisting of perfluoroaryl, perfluoroalkyl, and perfluoroalkyl-substituted moieties.

5. The catalyst composition of claim 1, wherein the cocatalyst is triphenylcarbenium tetrakis (pentafluorophenyl)borate.

6. The catalyst composition of claim 1 in liquid form.

7. The catalyst composition of claim 1 further comprising an inert support.

8. A process for preparing a cycloalkadienyl/metal catalyst precursor, which comprises reacting a homoleptic metal alkyl complex with an alkaline or alkaline earth metal salt of a cycloalkadiene.

9. A process for preparing a cycloalkadienyl/metal catalyst precursor, which comprises reacting a metal alkyl-borate salt with an alkaline metal or alkaline earth metal salt of a cycloalkadiene.

10. A process for preparing a cycloalkadienyl/metal catalyst precursor, which comprises reacting a metal alkyl-borate salt with a cycloalkadiene.

11. A process for the polymerization of olefins, which comprises contacting olefins under polymerization conditions with a catalyst composition comprising:
a) a catalyst precursor of the formula LMⁿ⁺(X)_{y}(R)_{(n-y-1)}, wherein L is a cycloalkadienyl ligand except for cyclopentadienyl and pentamethylcyclopentadienyl; M is an element selected from Groups 3 to 10 and the Lanthanides; each X is an anion; each R is a hydride or a group containing at least two carbons capable of attachment to M in a multihapto manner through at least one hydrogen or carbon atom; n is the valence of M; and y is an integer from 0 to 5;
b) a cocatalyst capable of irreversibly abstracting an X or an R from the catalyst precursor such that at least one metal-carbon or metal-hydrogen bond is retained in the resulting activated catalyst.

12. The process of claim 11, wherein the catalyst precursor has the formula:
LMⁿ⁺(CH₂Ph)ₙ₋₁
wherein L is a cycloalkadienyl ligand except for cyclopentadienyl and pentamethylcyclopentadienyl; M is an element selected from Groups 3 to 10 and the Lanthanides; n is the valence of M; y is an integer from 0 to 5; and Ph is phenyl.

13. The process of claim 11, wherein the catalyst precursor has a formula selected from the group consisting of:

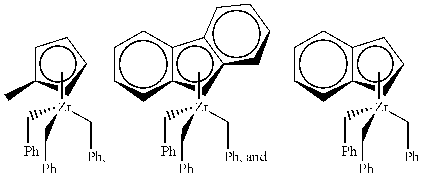

14. The process of claim 11, wherein the cocatalyst is a borate of the formula BR″₄_{⁻}, wherein R″ is selected from the group consisting of perfluoroaryl, perfluoroalkyl, and perfluoroalkyl-substituted moieties.

15. The process of claim 11, wherein the cocatalyst is triphenylcarbenium tetrakis (pentafluorophenyl)borate.

16. The process of claim 11 conducted in the gas phase.

17. The process of claim 11, wherein the catalyst composition is in liquid form.

18. The process of claim 11, wherein the catalyst composition further comprises an inert support.
